(19) United States
(12) Patent Application Publication
(10) Pub. No.: US 2026/0138673 A1
(43) Pub. Date: May 21, 2026

(54) REVERSE DOCKING ASSISTANCE SYSTEM USING ULTRASONIC DETECTION

(71) Applicant: STONERIDGE ELECTRONICS AB, Solna (SE)

(72) Inventor: John Couperthwaite, Ypsilanti, MI (US)

(21) Appl. No.: 19/118,816

(22) PCT Filed: Oct. 19, 2022
(86) PCT No.: PCT/US2022/047114

§ 371 Date: Apr. 7, 2025

(51) Int. Cl. B62D 15/02; B60R 1/26; B62D 13/06; G01S 15/89; G06T 11/10; G06T 11/60

(52) U.S. Cl. CPC B62D 15/0295; B60R 1/26; B62D 13/06; G01S 15/89; G06T 11/10; G06T 11/60; B60R 2300/308; B60R 2300/8046; B60R 2300/8086; G06T 2210/21

(57) ABSTRACT

A method of assisting a reversing maneuver for a tractor trailer includes determining a predicted trailer path based at least in part on a steering angle of a tractor, identifying a position of an adjacent object adjacent the trailer using ultrasonic sensors, and identifying a state of the predicted path as one of a correct state, an incorrect but correctible state, and an uncorrectable state. The state is obtained by determining if the predicted path results in a portion of the trailer intersect with the position of the at least one adjacent object. After determining the state, the method identifies a steering angle correction capable of adjusting the predicted path such that no portion of the trailer intersects the adjacent object.

### TECHNICAL FIELD

This disclosure relates to commercial vehicle docking assistance.

### BACKGROUND

Mirror replacement systems, camera systems for supplementing mirror views, and other camera monitoring systems are utilized in commercial vehicles to enhance the ability of a vehicle operator to see a surrounding environment. Camera monitoring systems (CMS) utilize one or more cameras to provide an enhanced field of view to a vehicle operator. In some examples, the mirror replacement systems cover a larger field of view than a conventional mirror, or include views that are not fully obtainable via a conventional mirror.

Driver assist systems, semi-automated driver assist systems, and other vehicle systems, use or require knowledge about the relative location of the trailer and objects that the trailer is navigating through to determine a projected path of the trailer and to provide warnings when the trailer is about to collide with an adjacent object. In addition to the information required from the relative positions, the direction of travel, the rate of travel, and similar information about vehicle operations is necessary to accurately predict the physical movement of the tractor and trailer.

### SUMMARY

An exemplary method of providing for assisting a reversing maneuver for a tractor trailer includes determining a predicted trailer path of a trailer based at least in part on a steering angle of a tractor, identifying a position of at least one adjacent object, relative to the trailer, using a set of ultrasonic sensors disposed about the trailer, identifying a state of the predicted path as one of a correct state, an incorrect but correctible state, and an uncorrectable state by determining if the predicted path results in a portion of the trailer intersecting with the position of the at least one adjacent object and identifying a steering angle correction capable of adjusting the predicted path such that no portion of the trailer intersects with the position of the at least one adjacent object in response to detecting that the portion of the trailer is expected to intersect with the position of the at least one adjacent object absent the correction, and displaying one of a no path adjustment needed message, a path adjustment message, and a no path correction possible message based on the state of the predicted path.

In another example of the above described method of providing for assisting a reversing maneuver for a truck trailer the path adjustment message includes a steering angle adjustment instruction.

In another example of any of the above described methods of providing for assisting a reversing maneuver for a truck trailer the steering angle adjustment includes at least one of an icon indicating an adjustment direction and magnitude and a textual descriptor of a direction and angle of the steering angle adjustment.

In another example of any of the above described methods of providing for assisting a reversing maneuver for a truck trailer the adjustment message includes color coding indicating a magnitude of the correction required.

In another example of any of the above described methods of providing for assisting a reversing maneuver for a truck trailer the predicted trailer path is determined using a kinematic model.

In another example of any of the above described methods of providing for assisting a reversing maneuver for a truck trailer identifying the position of at least one adjacent object, relative to the trailer, using a set of ultrasonic sensors disposed about the trailer comprises generating an ultrasonic point cloud defining the relative position of each object proximate to the trailer.

Another example of any of the above described methods of providing for assisting a reversing maneuver for a truck trailer further includes displaying a distance marker indicating a shortest distance between a trailer and an adjacent object on each side of the trailer.

Another example of any of the above described methods of providing for assisting a reversing maneuver for a truck trailer further includes displaying a distance marker indicating a shortest distance from a rear of the trailer to an object behind the trailer.

In another example of any of the above described methods of providing for assisting a reversing maneuver for a truck trailer the one of a no path adjustment needed message, a path adjustment message, and a no path correction possible message based on the state of the predicted path is displayed as an overlay on top of a mirror replacement image.

In another example of any of the above described methods of providing for assisting a reversing maneuver for a truck trailer the mirror replacement image is an image stitched from a driver's side rear facing camera and a passenger side rear facing camera.

Another example of any of the above described methods of providing for assisting a reversing maneuver for a truck trailer further includes generating a visual overlay of the predicted trailer path and applying the visual overlay to the mirror replacement image.

In another example of any of the above described methods of providing for assisting a reversing maneuver for a truck trailer the visual overlay of the predicted trailer path includes a shading a region of the image across which the trailer is expected to traverse.

In another example of any of the above described methods of providing for assisting a reversing maneuver for a truck trailer displaying the path adjustment message includes changing the shading to a first color and displaying the no path correction possible message includes changing the shading to a second color.

Another example of any of the above described methods of providing for assisting a reversing maneuver for a truck trailer further includes generating and displaying a top down view of the trailer, wherein the top down view of the trailer includes the predicted trailer path and the one of the no path adjustment needed message, the path adjustment message, and the no path correction possible message based on the state of the predicted path message.

In one exemplary embodiment a vehicle controller includes a processor and a memory, the memory storing instructions for causing the processor to determine a predicted trailer path of a trailer based at least in part on a steering angle of a tractor, identify a position of at least one adjacent object, relative to the trailer, using a set of ultrasonic sensors disposed about the trailer, identify a state of the predicted path as one of a correct state, an incorrect but correctible state, and an uncorrectable state by determining if the predicted path results in a portion of the trailer intersecting with the position of the at least one adjacent object and identifying a steering angle correction capable of adjusting the predicted path such that no portion of the trailer intersects with the position of the at least one adjacent object in response to detecting that the portion of the trailer is expected to intersect with the position of the at least one adjacent object absent the correction, and causing a screen to display one of a no path adjustment needed message, a path adjustment message, and a no path correction possible message based on the state of the predicted path.

Another example of the above described vehicle controller further includes a plurality of ultrasonic sensors disposed about the trailer, each of the ultrasonic sensors being connected to the processor such that the processor receives a sensor output of the ultrasonic sensors.

In another example of any of the above described vehicle controllers the vehicle controller is a component of a camera monitoring system.

### BRIEF DESCRIPTION OF THE DRAWINGS

The disclosure can be further understood by reference to the following detailed description when considered in connection with the accompanying drawings wherein:

FIG. 1A is a schematic front view of a commercial truck with a camera monitoring system (CMS) used to provide at least Class II and Class IV views.

FIG. 1B is a schematic top elevational view of a commercial truck with a camera monitoring system providing Class II, Class IV, Class V and Class VI views.

FIG. 2 is a schematic top perspective view of a vehicle cabin including displays and interior cameras.

FIG. 3 illustrates an exemplary reversing maneuver of a commercial vehicle into a loading bay.

FIG. 4 illustrates an exemplary reversing operation at a correct trailer angle using a first display configuration.

FIG. 5 schematically illustrates an exemplary reversing operation at a correctable trailer angle using the first display configuration

FIG. 6 schematically illustrates an exemplary reversing operation at an uncorrectable trailer angle using the first display configuration.

FIG. 7 illustrates an exemplary reversing operation at a correct trailer angle using a second display configuration.

FIG. 7 schematically illustrates an exemplary reversing operation at a correctable trailer angle using the second display configuration.

FIG. 9 schematically illustrates an exemplary reversing operation at an uncorrectable trailer angle using the second display configuration.

FIG. 10 illustrates a processor operating a reverse assist system.

The embodiments, examples and alternatives of the preceding paragraphs, the claims, or the following description and drawings, including any of their various aspects or respective individual features, may be taken independently or in any combination. Features described in connection with one embodiment are applicable to all embodiments unless such features are incompatible.

### DETAILED DESCRIPTION

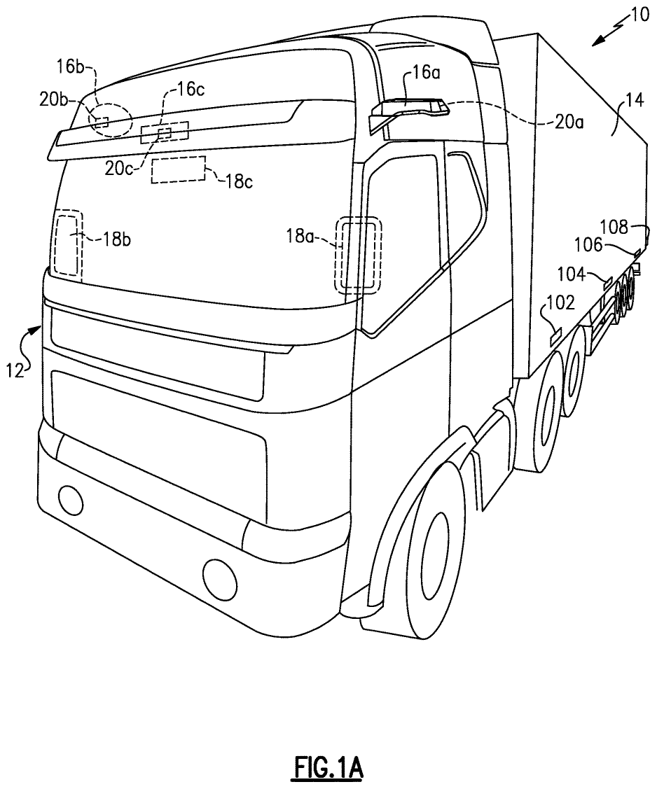

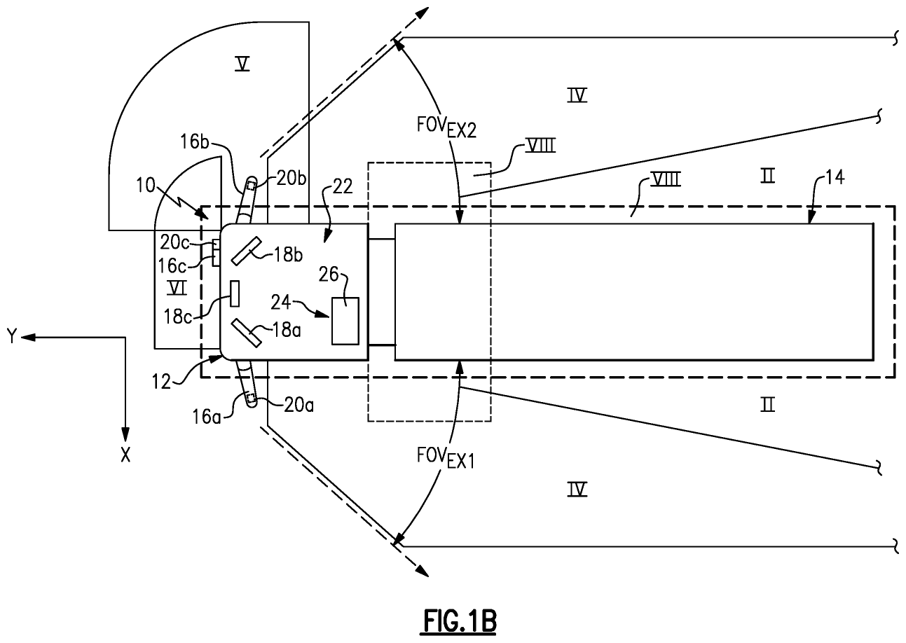

A schematic view of a commercial vehicle 10 is illustrated in FIGS. 1A and 1B. FIG. 2 schematically illustrates an interior of the vehicle cab. The vehicle 10 includes a vehicle cab or tractor 12 for pulling a trailer 14. Although a commercial truck is contemplated in this disclosure, the invention may also be applied to other types of vehicles and is not limited to commercial vehicles. The vehicle 10 incorporates a camera monitoring system (CMS) 15 (illustrated in FIG. 2) that has driver and passenger side camera arms 16a, 16b mounted to the outside of the vehicle cab 12. If desired, the camera arms 16a, 16b may include conventional mirrors integrated with them as well, although the CMS 15 can be used to entirely replace mirrors. In additional examples, each side can include multiple camera arms, each arm housing one or more cameras and/or mirrors.

Each of the camera arms 16a, 16b includes a base that is secured to, for example, the cab 12. A pivoting arm is supported by the base and may articulate relative thereto. At least one rearward facing camera 20a, 20b is arranged respectively within camera arms. The exterior cameras 20a, 20b respectively provide an exterior field of view FOV_{EX1}, FOV_{EX2} that each include at least one of the Class II and Class IV views (FIG. 1B), which are legal prescribed views in the commercial trucking industry. Multiple cameras also may be used in each camera arm 16a, 16b to provide these views, if desired. Each arm 16a, 16b may also provide a housing that encloses electronics that are configured to provide various features of the CMS 15.

First and second video displays 18a, 18b are arranged on each of the driver and passenger sides within the vehicle cab 12 on or near the A-pillars 19a, 19b to display Class II and Class IV views on its respective side of the vehicle 10, which provide rear facing side views along the vehicle 10 that are captured by the exterior cameras 20a, 20b.

If video of Class V and Class VI views are also desired, a camera housing 16c and camera 20c may be arranged at or near the front of the vehicle 10 to provide those views (FIG. 1B). A third display 18c arranged within the cab 12 near the top center of the windshield can be used to display the Class V and Class VI views, which are toward the front of the vehicle 10, to the driver.

If video of class VIII views is desired, camera housings can be disposed at the sides and rear of the vehicle 10 to provide fields of view including some or all of the class VIII zones of the vehicle 10. In such examples, the third display 18c can include one or more frames displaying the class VIII views. Alternatively, additional displays can be added near the first, second and third displays 18a, 18b, 18c and provide a display dedicated to providing a class VIII view. The displays 18a, 18b, 18c face a driver region 24 within the cabin 22 where an operator is seated on a driver seat 26.

Included on the trailer 14 are multiple ultrasonic sensors 102, 104, 106, 108. The ultrasonic sensors 102-108 provide a short range point cloud detection that identifies objects adjacent to the trailer 14, and identifies the distance between those objects and the trailer 14. These detections are provided to the camera monitoring system (CMS 15) and/or another vehicle controller in communication with the CMS 15 via any conventional sensor communication method. The CMS 15 and/or a vehicle controller in communication with the CMS 15 includes a docking assist program that determines an ideal reversing route for backing the trailer 16 into a corresponding loading dock. In other examples, other reversing maneuvers can use the same process based on the ultrasonic sensor position detections, and the assist system is not limited to docking maneuvers. The docking assist program cause prompts and/or instructions to be displayed over top of the views in the display panels 18a, 18b with the instructions assisting the vehicle operator in correctly performing the reversing maneuver.

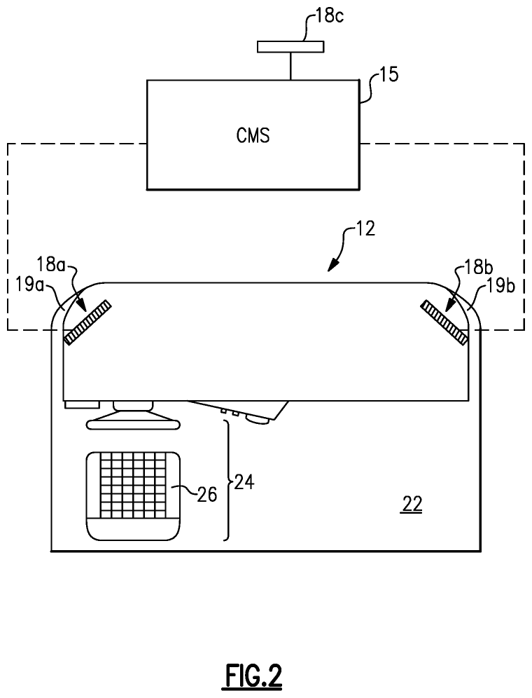

With continued reference to FIGS. 1A-2, FIG. 3 schematically illustrates an exemplary reversing operation 200 in which a tractor 210 is reversing a trailer 220 into a loading dock 230. The particular space 232 corresponding to the loading dock 230 is disposed between two adjacent parked trailers 240. In alternative environments, the trailers 240 can be replaced with any other type of obstruction, and the system functions in the same manner.

In order to properly slot the trailer 220 into the loading dock 230, the controller operating the docking assist program determines that the trailer 220 should follow a path 222, and that this trailer path 222 can be achieved by moving hitch point connecting the tractor 210 to the trailer 222 along a hitch point path 212. The path can be determined by the controller using any kinematic path estimation model. The hitch point path 212 is directly controlled by the steering of the tractor 210 as it is fixed relative to the tractor 210. In contrast, the trailer path 222 includes some variations due to the ability of the trailer 220 to turn relative to the tractor 210 at the hitch point 214.

Instructions can be provided to the vehicle operator as to how to follow the trailer path 222, and the instructions can include requested corrections to the operations to shift form a current path to the correct path 222. In one example requested steering corrections could be specified at the steering wheel and in another example the requested steering correction could be relative to the trailer orientation. In the former, the driver is told to rotate the steering wheel to the left which results in the trailer being steered to the left or right. This example is referred to as steering wheel instructions. In the later, the driver is told to steer the trailer to the left which would require the driver to rotate the steering wheel to the left or right. This example is referred to as trailer steered instruction.

In order to assist the driver/operator of the tractor 210 in properly slotting the trailer 220 into the loading dock 230, the docking assist program uses ultrasonic sensors 202, 204, 206, 208 disposed on the sides and ends of the trailer 220 to determine distances 250 between the sensors 202-208 and the objects (such as the trailers 240) that are adjacent to the slot 232 for the trailer 220 to dock in. This information is used to create a point cloud identifying the positions of adjacent objects relative to the trailer 220. In addition to the information from the ultrasonic sensors, the controller operating the docking assistance program receives operational information from a steering angle sensor, as well as other vehicle information available through a connection to the vehicle controller. The received information is used in conjunction with a kinematic model to determine if the current operation will maintain the trailer 220 along the trailer path 222. If the operating parameters are incorrect, the driver determines a corrective action and provides the corrective action to the operator via one or more displays 18a, 18b, 18c in the cab.

During a reverse docking maneuver, such as one following the path 222, the vehicle can be in three possible states: A correct path, An incorrect but correctable path, and An incorrect and uncorrectable path.

A correct path is a state where the relative position of the trailer 220 and the adjacent objects 240 combined with the current steering angle from the cab results in a reversing path that will correctly slot the trailer 220 into the corresponding dock 230.

An incorrect, but correctible path is a state where the relative position of the trailer 220 and the adjacent objects 240 combined with the current steering angle results in a reversing path that will collide with one of the adjacent objects 240, but the path can be corrected while maintaining the reversing maneuver via a steering angle correction, or via another maneuvering correction.

An incorrect and uncorrectable path is a state where continuing the reversing maneuver will result in a collision with one or both of the adjacent objects 240, and where there is not a steering correction that can rectify the path. In such a state, the docking assist program instructs the driver to exit the lane and restart the maneuver.

With continued reference to FIGS. 1A-3, FIG. 4 schematically illustrates an example correct path state via a top down image 310 and a corresponding display(s) 320 that is shown to the vehicle operator. While illustrated in the example Figures as two images proximate each other, it should be appreciated that the display(s) 320 can be separate display monitors, separate images within a single display monitor, or any other configuration able to display the images. In the correct path state, the trailer 312 is reversing into the dock 311 and the ultrasonic sensors (illustrated in FIGS. 1A-2) determine distances 314, 316 between the trailer and each adjacent object 318 and the dock 311. The adjacent objects 318 can be additional trailers, loading bays, loading docks, or any other structural features that could collide with the trailer 312.

The ultrasonic sensors determine that the left side of the trailer is 7 feet away from the adjacent object, the right side of the trailer is 8 feet away from the adjacent object, and the rear of the trailer is 34 feet from the dock 311. Based on these determinations, and the steering angle of the cab, the docking assist system determines that the reversing maneuver can continue without assistance. After determining that the maneuver can continue without assistance, the docking assist program provides an overlay display(s) 320 on the class IV views on the displays 18a, 18B. The overlay includes a distance indicator 322, 324 indicting the distance from each side of the trailer to the adjacent objects 318, and a dock distance indicator 326 indicating a distance to the dock 311. In some example, the indicators can be displayed using a color coding with the color of the display indicating that the maneuver can proceed without alteration.

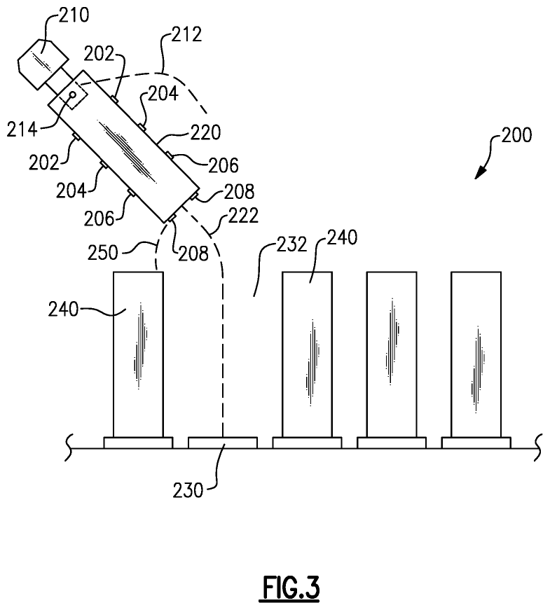

With continued reference to FIG. 4, and with like numerals indicating like elements, FIG. 5 schematically illustrates an example incorrect but correctible path state in the same display system as that of FIG. 4. Unlike the state of FIG. 4, the incorrect, but correctible state identifies the rear left side of the trailer 312 as being too close to the left object 318 and the front right side of the trailer 312 as being too close to the right object 318. Once it has been determined that the points of the trailer 312 are too close to the corresponding objects 318, the controller determines that the vehicle operator can correct the operation by adjusting the steering to steer left. This instruction is displayed to the operator via a warning prompt 330 that is displayed prominently overlaying the screen. The illustrated warning prompt 330 is a text instruction. In alternative examples, the warning prompt can take any form that clearly and unambiguously identifies that the current path is incorrect and correctible, as well as identifying the vehicle operation (e.g., steering adjustment) that is required to correct the path.

With continued reference to FIGS. 4 and 5, and with like numerals indicating like elements, FIG. 6 illustrates what occurs when the driver or vehicle operator fails to follow the prompt described above and/or otherwise results in an incorrect and not correctible maneuvering operation. When the vehicle enters the uncorrectable state, the prompt 330 changes from instructions for correcting the maneuver to instructions for pulling out of the slot 232 and restarting the reversing maneuver. In some examples, the change in prompt can be further emphasized by altering the color of the prompt (e.g. shifting from yellow to red), by visual effects (e.g. flashing), by accompanying audio signals, and/or by any other means.

With continued reference to FIGS. 4, 5 and 6, it is appreciated that in some examples the top down image 310 can be generated and displayed to the vehicle operator during the maneuver on a separate screen. In such an example, the prompt 330 and informational displays can be provided to the user on the top down image as well.

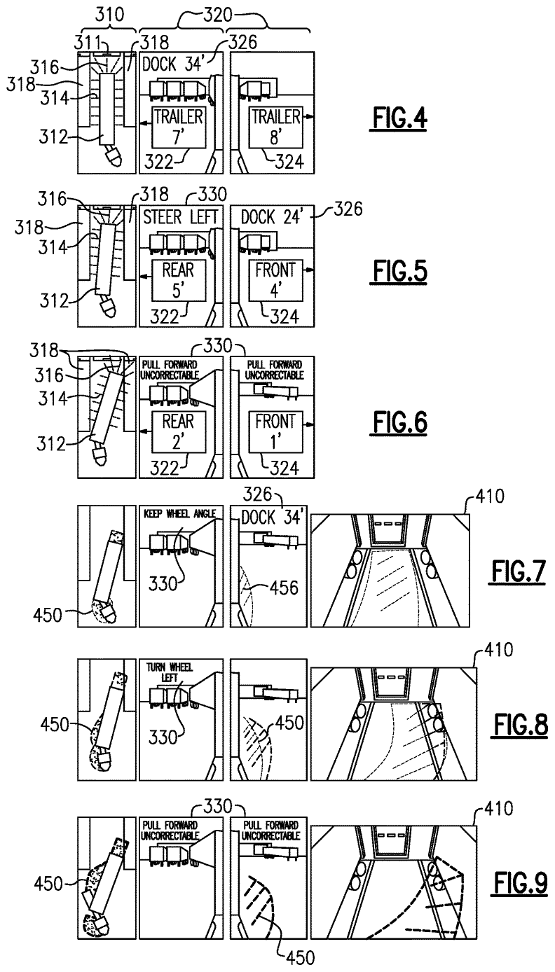

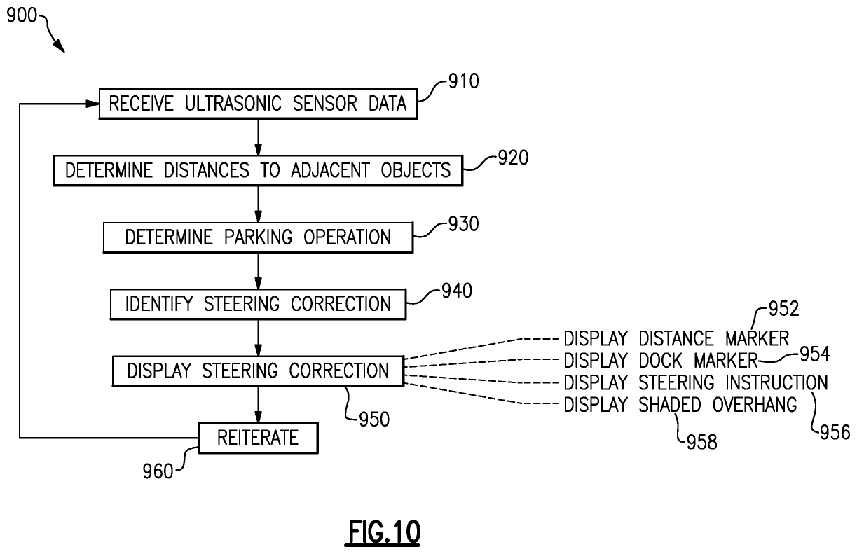

In some cases, the information provided through the text prompts and text displays 322, 324, 330, can be supplemented using additional shaded overlays 450 illustrating the desired path and the projected path. With reference to FIGS. 4-6, FIGS. 7-9 illustrate the same states, with FIG. 7 corresponding to FIG. 4, FIG. 8 corresponding to FIG. 5, and FIG. 9 corresponding to FIG. 6. The examples of FIGS. 7-9 add an additional projection screen 410 and an additional overlay 450 on the display(s) 320. The additional overlay 450 provides a projection in the image of where the trailer will pass on the current path. The overlay 450 is, in some instances, color coded to indicate when the trailer 312 will come close to an object (by turning yellow) and when the trailer 312 will intersect with or cross over an object (by turning red).

With reference to all preceding Figures, FIG. 10 illustrates a method 900 for operating the system described herein. Initially the controller operating the system receives the distance measurements from the ultrasonic sensors in a “Receive Ultrasonic Sensor Data” step 910. The distance is used by the controller to determine a set of distances between the trailer and the adjacent objects in a “Determine Distances to Adjacent Objects” step 920. Based on the set of determined distances, a parking operation capable of placing the trailer in the correct position is determined in a “Determine Parking Operation” step 930.

After determining the parking operation that will result in the correct placement of the trailer, the driver assist system determines a steering correction (if any) that will allow the trailer to follow the determined parking operation in an “Identify Steering Correction” step 940. The identified steering correction is output to a display portion of the camera monitoring system, and displayed to the user inn a “display Steering Correction” step 950. The displayed steering correction, can include one, multiple, or all of a distance marker, a dock marker, a specific steering instruction, and a shaded overlay. Each of the elements is created in a substep 952, 954, 956, 958 that is operated within the Display Steering Correction step 950.

By way of example, FIGS. 4, 5 and 6 include the distance indicators, 322, 324 the dock distance indicator 326 and the trailer steered instruction 330. Similarly, the example of FIGS. 7, 8 and 9 includes the steering wheel instruction 330, a dock distance indicator 326, and the shaded overly 450. The process is then reiterated for the duration of the parking operation, via a reiterate loop 960.

While described above with regards to a docking maneuver, it should be understood that the process and system can be utilized with any reversing maneuver including parking, docking, reversing out of parked position, or any similar reversing maneuver.

Although an example embodiment has been disclosed, a worker of ordinary skill in this art would recognize that certain modifications would come within the scope of the claims. For that reason, the following claims should be studied to determine their true scope and content.

What is claimed is:

1. A method of providing for assisting a reversing maneuver for a tractor trailer comprising:
determining a predicted trailer path of a trailer based at least in part on a steering angle of a tractor;
identifying a position of at least one adjacent object, relative to the trailer, using a set of ultrasonic sensors disposed about the trailer;
identifying a state of the predicted path as one of a correct state, an incorrect but correctible state, and an uncorrectable state by determining if the predicted path results in a portion of the trailer intersecting with the position of the at least one adjacent object and identifying a steering angle correction capable of adjusting the predicted path such that no portion of the trailer intersects with the position of the at least one adjacent object in response to detecting that the portion of the trailer is expected to intersect with the position of the at least one adjacent object absent the correction; and
displaying one of a no path adjustment needed message, a path adjustment message, and a no path correction possible message based on the state of the predicted path.

2. The method of claim 1, wherein the path adjustment message includes a steering angle adjustment instruction.

3. The method of claim 2, wherein the steering angle adjustment includes at least one of an icon indicating an adjustment direction and magnitude and a textual descriptor of a direction and angle of the steering angle adjustment.

4. The method of claim 3, wherein the adjustment message includes color coding indicating a magnitude of the correction required.

5. The method of claim 1, wherein the predicted trailer path is determined using a kinematic model.

6. The method of claim 1, wherein identifying the position of at least one adjacent object, relative to the trailer, using a set of ultrasonic sensors disposed about the trailer comprises generating an ultrasonic point cloud defining the relative position of each object proximate to the trailer.

7. The method of claim 6, further comprising displaying a distance marker indicating a shortest distance between a trailer and an adjacent object on each side of the trailer.

8. The method of claim 6, further comprising displaying a distance marker indicating a shortest distance from a rear of the trailer to an object behind the trailer.

9. The method of claim 1, wherein the one of a no path adjustment needed message, a path adjustment message, and a no path correction possible message based on the state of the predicted path is displayed as an overlay on top of a mirror replacement image.

10. The method of claim 9, wherein the mirror replacement image is an image stitched from a driver's side rear facing camera and a passenger side rear facing camera.

11. The method of claim 9, further comprising generating a visual overlay of the predicted trailer path and applying the visual overlay to the mirror replacement image.

12. The method of claim 11, wherein the visual overlay of the predicted trailer path includes a shading a region of the image across which the trailer is expected to traverse.

13. The method of claim 12, wherein displaying the path adjustment message includes changing the shading to a first color and displaying the no path correction possible message includes changing the shading to a second color.

14. The method of claim 1, further comprising generating and displaying a top down view of the trailer, wherein the top down view of the trailer includes the predicted trailer path and the one of the no path adjustment needed message, the path adjustment message, and the no path correction possible message based on the state of the predicted path message.

15. A vehicle controller comprising:
a processor and a memory, the memory storing instructions for causing the processor to determine a predicted trailer path of a trailer based at least in part on a steering angle of a tractor, identify a position of at least one adjacent object, relative to the trailer, using a set of ultrasonic sensors disposed about the trailer, identify a state of the predicted path as one of a correct state, an incorrect but correctible state, and an uncorrectable state by determining if the predicted path results in a portion of the trailer intersecting with the position of the at least one adjacent object and identifying a steering angle correction capable of adjusting the predicted path such that no portion of the trailer intersects with the position of the at least one adjacent object in response to detecting that the portion of the trailer is expected to intersect with the position of the at least one adjacent object absent the correction, and causing a screen to display one of a no path adjustment needed message, a path adjustment message, and a no path correction possible message based on the state of the predicted path.

16. The vehicle controller of claim 15, further comprising a plurality of ultrasonic sensors disposed about the trailer, each of the ultrasonic sensors being connected to the processor such that the processor receives a sensor output of the ultrasonic sensors.

17. The vehicle controller of claim 15, wherein the vehicle controller is a component of a camera monitoring system.
